(19) United States
(12) Patent Application Publication
(10) Pub. No.: US 2013/0045793 A1
(43) Pub. Date: Feb. 21, 2013

(54) ELECTRONIC SENSING COIN ACCEPTOR

(71) Applicant: YUN-LAN CHENG, TAINAN CITY (TW)

(72) Inventor: YUN-LAN CHENG, TAINAN CITY (TW)

(21) Appl. No.: 13/213,183

(22) Filed: Aug. 19, 2011

(51) Int. Cl. A63F 9/24; G07D 5/00

(52) U.S. Cl. 463/25; 194/302

(57) ABSTRACT

An electronic sensing coin acceptor includes at least one electronic access device having a casing with a space defined therein, and a memory device is located in the space. A control device is electrically coupled to a reader, a signal output unit, a sensor and a control valve. The information, internal codes and credit information are checked by the sensor which is set to be the default electronic access device so that only the tokens or coins that are accepted by the electronic access device can be used.

### FIELD OF THE INVENTION

The present invention relates to an electronic sensing coin acceptor, and more particularly, to a coin acceptor with electronic access device and identification device to check fake coins inserted into the coin acceptor.

### BACKGROUND OF THE INVENTION

The conventional electronic sensing coin acceptor is cheated by the defects of the sensing device thereof and there are several types of the conventional electronic sensing coin acceptors, which are the weight sensing coin acceptor, thickness sensing coin acceptor, diameter sensing coin acceptor, and sound sensing coin acceptor. For the weight sensing coin acceptor, the weight of the coin that enters into the coin acceptor is sensed so as to guide to the correct path to activate the electronic game player. However, when a fake coin has the same weight as the real coin, the weight sensing device cannot tell the difference.

For the thickness sensing coin acceptor, the paths in the coin acceptor are inclined so that the coins of different thicknesses will go through different paths so as to distinguish the fake coins or the real coins. Nevertheless, the thickness can be made to cheat the thickness sensing coin acceptor.

For the diameter sensing coin acceptor, there is a resilient member located in the coin acceptor and the diameter of the coin entering the coin acceptor is measured. If the fake coin enters, the difference of the diameter is detected and the fake coins are kicked out. However, the thickness of the coins can be easily copied.

For the sound sensing coin acceptor, the impact frequency of the coin and the inside of the path is detected, if the fake coin hits the wall, the frequency is detected to be different from the pre-set frequency, so that the fake coins are detected. However, the impact frequency can be carefully copied as well.

If the cheating actions mentioned cannot be stopped, significant lost of money will be made, therefore, an improved detection and/or sensing device is needed to stop the use of fake coins.

The present invention intends to provide an electronic sensing coin acceptor which improves the shortcomings mentioned above.

### SUMMARY OF THE INVENTION

The present invention relates to an electronic sensing coin acceptor and comprises at least one electronic access device which has a casing and a space is defined in the casing. A memory device is installed in the space for storing identification information. A control device is electrically coupled to a reader, a signal output unit, a sensor and a control valve, such that when the electronic access device passes through the reader, the reader reads the identification information stored in the memory device, and after the control device analyzes the identification information, the identification information is transmitted to the signal output unit, and the sensor including an identification device, such that when the electronic access device passes through the identification device, the identification device identifies the identification information stored in the memory device, and if the identification information is authenticated, then the identification device will turn on the control valve by the control device, so that the electronic access device can pass through the control valve, and if the identification information is not authenticated, then the control valve will not be turned on, and the electronic access device will be returned.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the electronic access device of the present invention;

FIG. 2 is a cross sectional view taken along line A-A in FIG. 1;

FIG. 3 shows the electronic access device of the present invention;

FIG. 4 shows the diagram of the parts of the electronic sensing coin acceptor;

FIG. 5 is the electronic sensing coin acceptor of the present invention;

FIG. 6 shows that when a fake coin or token that is larger than the accepted diameter of the electronic access device is entered into the coin acceptor;

FIG. 7 shows that when a fake coin or token that is smaller than the accepted diameter of the electronic access device is entered into the coin acceptor, and

FIG. 8 shows an acceptable coin or taken is entered into the coin acceptor.

### DETAILED DESCRIPTION OF THE PREFERRED EMBODIMENT

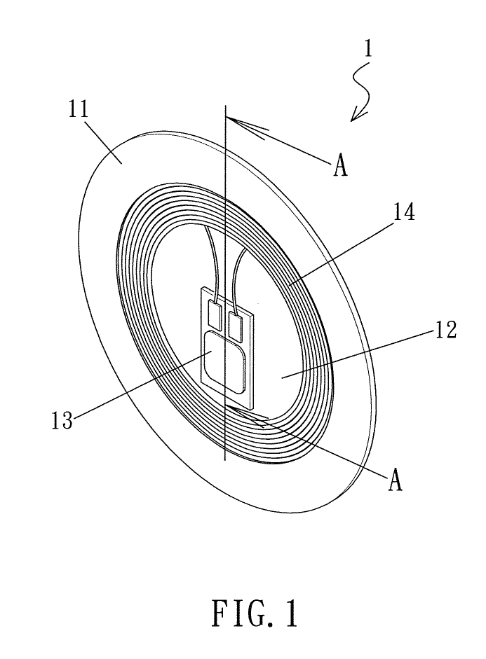

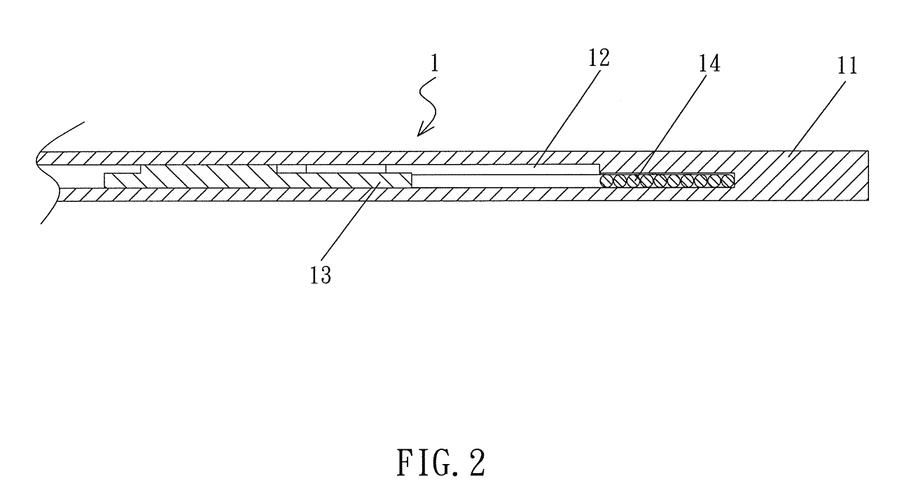

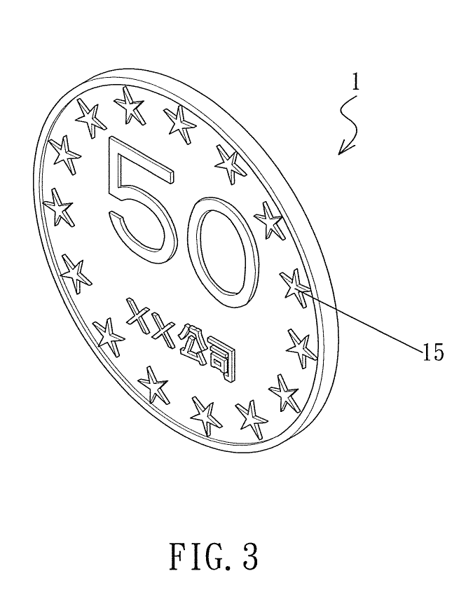

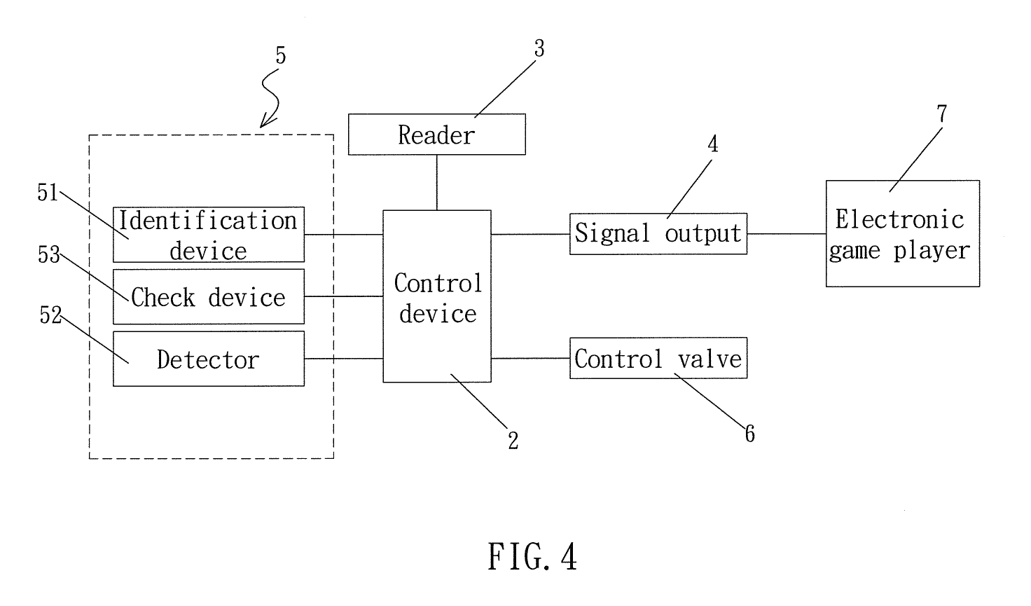

Referring to FIGS. 1 to 5, the electronic sensing coin acceptor of the present invention comprises at least one electronic access device 1 which can be an electronic token and has a casing 11 with a space 12 defined therein, and a memory device 13 is installed in the space 12 for storing identification information. The memory device 13 stores company information, internal codes, and credit limit information. Each electronic access device 1 of individual company includes different company information, internal codes, and credit limit information. The internal codes have a specific rule to prevent the memory device 13 from being copied. The electronic access device 1 further includes at least one conductive metal coil 14 installed in the space 12 and the at least one conductive metal coil 14 is electrically coupled to the memory device 13. A label with the same credit limit information is labeled on outside of the casing 11 of the electronic access device 1 as shown in FIG. 3. A coat 15 is mounted to the case 11 and includes the same information that is the same as the content of the memory device 13 of the company.

A control device 2 is electrically coupled to a reader 3, a signal output unit 4, a sensor 5 and a control valve 6. The signal output unit 4 is electrically connected to an electronic game player 7. When the electronic access device 1 passes through the reader 3, because the electronic access device 1 has the metal coil 14, the electronic access device 1 reads the reinforced signals more efficiently. The reader 3 reads the identification information stored in the memory device 13 such as the company information, internal codes, and credit limit information. The control device 2 analyzes the identification information which is then transmitted to the signal output unit 4 which sends the information to the electronic game player 7. The sensor 5 includes an identification device 51, when the electronic access device 1 passes through the identification device 51, the identification device 51 identifies the identification information stored in the memory device 13. Because the electronic access device 1 has the metal coil 14, the identification device 51 is easily to identify the reinforced signals. The identification device 51 activates the control valve 6 via the control device 2 so that the electronic access device 1 passes through the control valve 6. If the identification information is authenticated, the identification device 51 does not activate the control valve 6 and the electronic access device 1 is returned. The sensor 5 comprises a detector 52 to detect and confirm the electronic access device 1 passes through the control valve 6 or not. When the electronic access device 1 passes through the control valve 6, the detector 52 generates an acknowledge signal which is transmitted from the control device 2 to the signal output unit 4. Until this stage, the signal output unit 4 confirms to activate the electronic game player 7. When the electronic access device 1 does not pass through the control valve 2, the detector 52 does not generate the acknowledge signal, and the electronic game player 7 is not activated. The sensor 5 further comprises a check device 53 to prevent the electronic access device 1 from being forcibly pulled out from the control valve 6 after the electronic access device 1 passes through the detector 52, and then the check device 53 outputs an interrupt signal, the control device 2 transmits the interrupt signal to the signal output unit 4 to stop the electronic game player 7. The identification device 51, the detector 52 and the check device 53 are infrared interrupters. By this way, the identification device 51, the detector 52 and the check device 53 are able to precisely judge the position that electronic access device 1 passes.

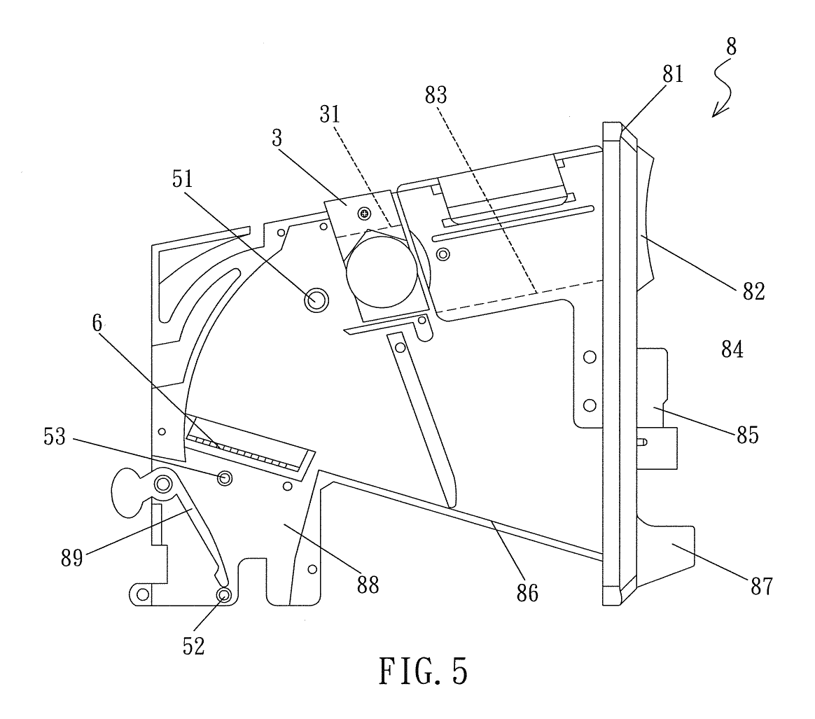

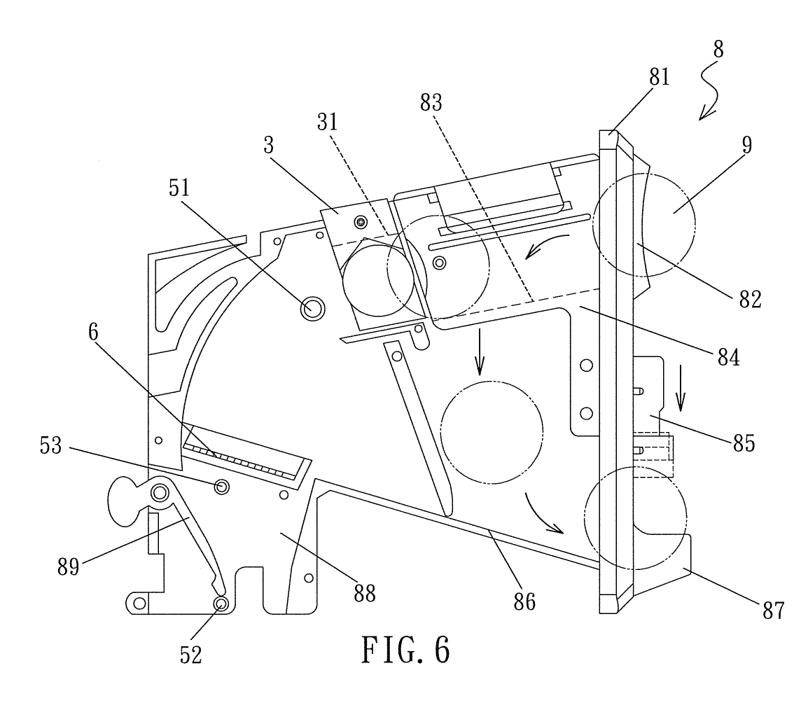

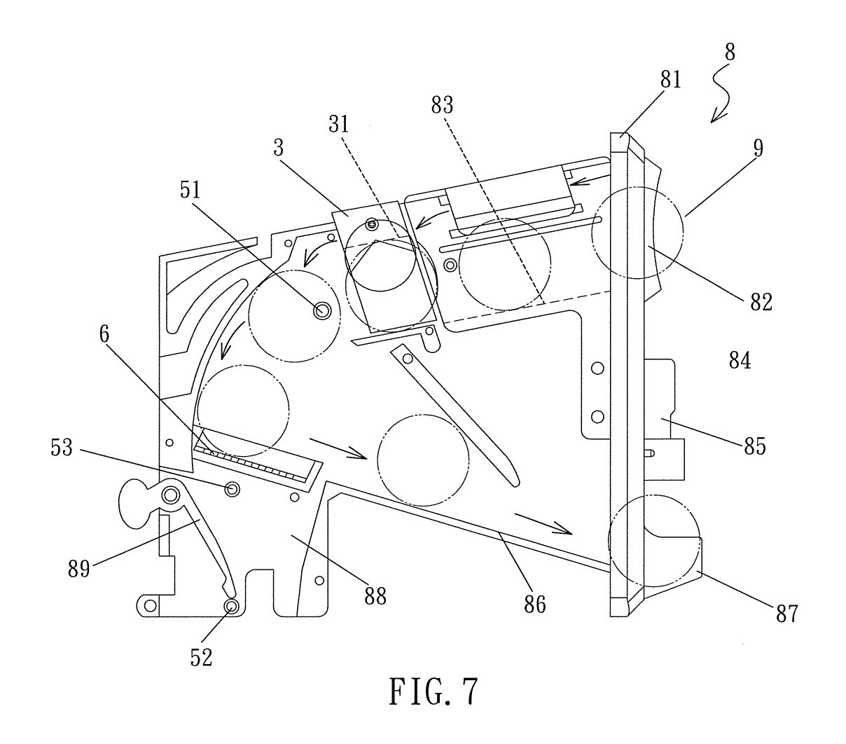

As shown in FIG. 5, the coin acceptor 8 includes a panel 81 which has an input end 82 and a path 83 extends from the input end 82 and reaches to the reader 3. The reader 3 has a passage 31 which is located corresponding to the size which allows the electronic access device 1 to pass. A return gate 84 is located on a vertical side to the path 83. The panel 81 has a lever 85 which is located corresponding to the return gate 84 which is opened by operation to the lever 85. The return gate 84 has a return way 86 connected to the lower end thereof. The reader 3 has the identification device 51 located corresponding to the path 83 and the control valve 6 is connected beneath the identification device 51. The control valve 6 intersects the insert path 88 which has the detector 52, the check device 53 and a one-way member 89 located therein. The control valve 6 is connected to the return way 86. When a fake coin 9 is inserted into the input end 82 and the diameter of the fake coin 9 is larger than the diameter of the electronic access device 1 as shown in FIG. 6, the fake coin 9 is stopped by the passage 31 and stocked between the path 83 and the passage 31. The user has to push the lever 85 to open the return gate 84 to retrieve the fake coin 9 from the output end 87. When a fake coin 9 is inserted into the input end 82 and the diameter of the fake coin 9 is smaller than the diameter of the electronic access device 1 as shown in FIG. 7, the fake coin 9 passes through the reader 3 and the passage 31, however, the reader 3 cannot read the identification information of the fake coin 9 so that no information is sent to the signal output unit 4. When the fake coin 9 passes through the identification device 5, because the company information, the internal codes, and the credit limit information are not acceptable or the sequence of the internal codes are not identified, or the fake coin 9 does not include proper value, or the fake coin 9 cannot be identified, the identification device 51 identifies the fake coin 9 is a fake coin so that the control valve 6 is not activated. The fake coin 9 is returned via the control valve 6, the return path 86 and the output end 87.

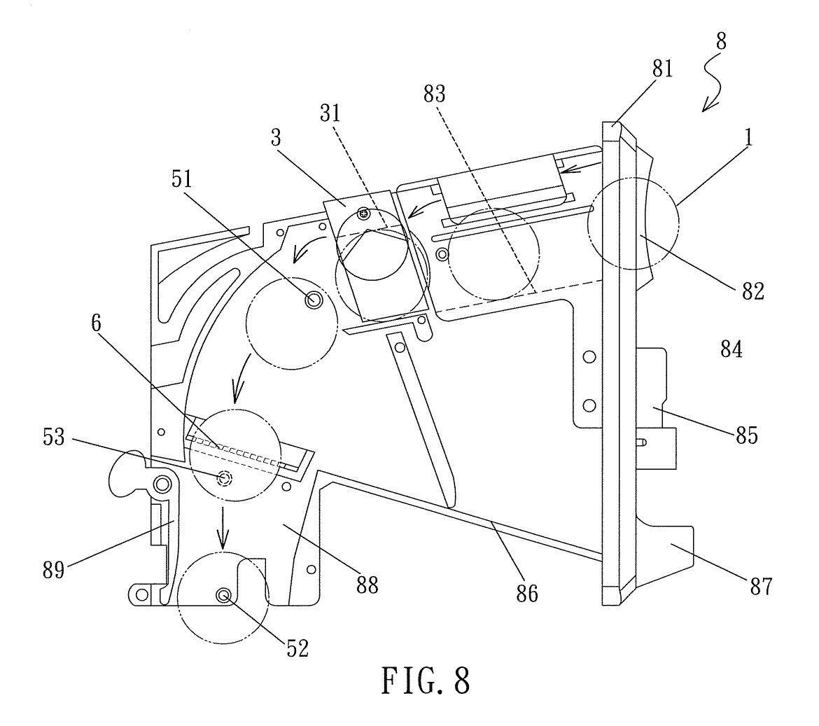

If the correct electronic access device 1 is inserted into the coin acceptor 8 via the input end 82 as shown in FIG. 8, the electronic access device 1 moves along the path 32 and passes through the reader 3 and the passage 31. The reader 3 reads the information stored in the memory device 13 including the company information, the internal codes, and the credit limit information. The information is analyzed by the control device 2 and sent to the electronic game player 7 via the signal output unit 4. The electronic access device 1 then passes through the identification device 51 which identifies the electronic access device 1 is correct and the company information, the internal codes, and the credit limit information are correct. The control valve 6 is activated via the control device 2 so that the electronic access device 1 passes through the control valve 6 and enters into the insert path 88, and then passes through the check device 53, the one-way member 89 and the detector 52. When the electronic access device 1 passes through the detection device 52 and drops into the collection tank (not shown) located beneath the insert path 88, the detection device 52 generates a confirm signal which is sent to the signal output unit 4. The electronic game player 7 is then activated. When the electronic access device 1 passes through the detection device 52 and is forcibly pulled out from the control valve 6, the check device 53 outputs an interrupt signal, the control device 2 transmits the interrupt signal to the signal output unit 4 to stop the electronic game player 7. The electronic access coin 9 that moves in opposite direction in the one-way member 89 will be stopped between the insert path 88 and the one-way member 89. Accordingly, if the value of the inserted electronic access device 1 does not reach the pre-set value to activate the electronic game player 7, the above steps have to be repeated until the pre-set value is met.

By the present invention, the electronic access device 1 can store the company information, the internal codes, and the credit limit information of the companies that have business connection so as to prevent fake tokens or coins to damage the business.

While we have shown and described the embodiment in accordance with the present invention, it should be clear to those skilled in the art that further embodiments may be made without departing from the scope of the present invention.

What is claimed is:

1. An electronic sensing coin acceptor, comprising:
at least one electronic access device having a casing, a space defined in the casing, a memory device installed in the space for storing identification information;
a control device electrically coupled to a reader, a signal output unit, a sensor and a control valve, when the electronic access device passes through the reader, the reader reads the identification information stored in the memory device, the control device analyzes the identification information which is transmitted to the signal output unit, and
the sensor including an identification device, when the electronic access device passes through the identification device, the identification device identifies the identification information stored in the memory device, if the identification information is authenticated, the identification device activates the control valve by the control device, so that the electronic access device passes through the control valve, if the identification information is not authenticated, the control valve is not activated, and the electronic access device is returned.

2. The electronic sensing coin acceptor of claim 1, wherein the electronic access device further includes at least one conductive metal coil installed in the space and electrically coupled to the memory device, when the electronic access device passes through the reader and the sensor, the sensing signal is enhanced to facilitate reading and sensing the sensing signal.

3. The electronic sensing coin acceptor of claim 1, wherein the identification information stored in the memory device comprises company information, internal codes, and credit limit information, a label with the same credit limit information is labeled on outside of the casing of the electronic access device.

4. The electronic sensing coin acceptor of claim 1, wherein the electronic access device is an electronic token.

5. The electronic sensing coin acceptor of claim 1, wherein the sensor comprises a detector to detect and confirm the electronic access device passes through the control valve, when the electronic access device passes through the control valve, the detector generates an acknowledge signal which is transmitted from the control device to the signal output unit, when the electronic access device does not pass through the control valve, the detector does not generate the acknowledge signal.

6. The electronic sensing coin acceptor of claim 5, wherein the sensor comprises a check device to prevent the electronic access device from being forcibly pulled out from the control valve after the electronic access device passes through the detector, and then the check device outputs an interrupt signal, the control device transmits the interrupt signal to the signal output unit.

7. The electronic sensing coin acceptor of claim 5, further comprising an electronic game player electrically coupled to the signal output unit, and when the electronic access device passes through the reader, the reader reads the identification information stored in the memory device, and after the control device analyzes the identification information, the signal output unit outputs the identification information to the electronic game player, and after the detector confirms that the electronic access device passes through the control valve, the acknowledge signal is generated and transmitted by the control device to the signal output unit, and by then the signal output unit confirms to activate the electronic game player.

8. The electronic sensing coin acceptor of claim 6, further comprising an electronic game player electrically coupled to the signal output unit, and when the electronic access device passes through the reader, the reader reads the identification information stored in the memory device, and after the control device analyzes the identification information, the signal output unit outputs the identification information to the electronic game player, and after the detector confirms that the electronic access device passes through the control valve, the acknowledge signal is generated and then transmitted by the control device to the signal output unit, and by then the signal output unit confirms to activate the electronic game player, and if the electronic access device is forcibly pulled out in a reverse direction from the electronic access device by an external force after the electronic access device passes through the detector, and by then the check device detects said action to generate an interrupt signal, and the control device transmits the interrupt signal to the signal output unit to force the signal output unit to stop the electronic game player.

9. The electronic sensing coin acceptor of claim 1, wherein the identification device is an infrared interrupter.

10. The electronic sensing coin acceptor of claim 6 or 8, wherein the detector and the check device are infrared interrupters.
